(19) United States
(12) Patent Application Publication
(10) Pub. No.: US 2021/0191371 A1
(43) Pub. Date: Jun. 24, 2021

(54) SUBSTRATE PROCESSING APPARATUS, SUBSTRATE PROCESSING SYSTEM, METHOD OF MANUFACTURING SEMICONDUCTOR DEVICE, AND RECORDING MEDIUM

(71) Applicant: KOKUSAI ELECTRIC CORPORATION, Tokyo (JP)

(72) Inventor: Kazuhide ASAI, Toyama-shi (JP)

(73) Assignee: KOKUSAI ELECTRIC CORPORATION, Tokyo (JP)

(21) Appl. No.: 17/126,227

(22) Filed: Dec. 18, 2020

(30) Foreign Application Priority Data
Dec. 20, 2019 (JP) 2019-229939

(51) Int. Cl. G05B 19/418; H01L 21/67

(52) U.S. Cl. CPC G05B 19/4185; H01L 21/0217; H01L 21/67167

(57) ABSTRACT

There is provided a technique that includes: a processor configured to process a substrate; a transceiver connected to a group management apparatus such that the transceiver can communicate with the group management apparatus, the transceiver being configured to transmit and receive only telegram data to and from the group management apparatus; and a controller configured to be capable of controlling a process performed by the processor based on the telegram data received by the transceiver.

### CROSS-REFERENCE TO RELATED APPLICATION

This application is based upon and claims the benefit of priority from Japanese Patent Application No. 2019-229939, filed on Dec. 20, 2019, the entire contents of which are incorporated herein by reference.

### TECHNICAL FIELD

The present disclosure relates to a substrate processing apparatus, a substrate processing system, a method of manufacturing a semiconductor device, and a recording medium.

### BACKGROUND

In the related art, a substrate processing apparatus used in a process of manufacturing a semiconductor device may be connected to other apparatuses via a network and configured to respond to a remote control from the other apparatuses.

In a substrate processing apparatus connected to a network, for example, in a case where there is a virus infection from the network, an operation of the apparatus may be impaired, and as a result, a throughput of substrate processing may be adversely affected.

### SUMMARY

Some embodiments of the present disclosure provide a technique capable of improving a throughput of substrate processing.

According to an embodiment of the present disclosure, there is provided a technique that includes: a processor configured to process a substrate; a transceiver connected to a group management apparatus such that the transceiver can communicate with the group management apparatus, the transceiver being configured to transmit and receive only telegram data to and from the group management apparatus; and a controller configured to be capable of controlling a process performed by the processor based on the telegram data received by the transceiver.

### BRIEF DESCRIPTION OF DRAWINGS

The accompanying drawings, which are incorporated in and constitute a part of the specification, illustrate embodiments of the present disclosure.

FIG. 1 is a block diagram showing a schematic configuration example of an entire system of a substrate processing apparatus according to an embodiment of the present disclosure.

FIG. 2 is a schematic cross-sectional view showing a substrate processing unit constituting a substrate processing apparatus according to an embodiment of the present disclosure.

FIG. 3 is a schematic configuration view showing a substrate processing module constituting a substrate processing apparatus according to an embodiment of the present disclosure.

FIG. 4 is a block diagram showing a controller constituting a substrate processing apparatus according to an embodiment of the present disclosure.

FIG. 5 is a flow chart of an outline of a substrate processing process according to an embodiment of the present disclosure.

FIG. 6 is an explanatory view showing an example of table data of a telegram data size in a substrate processing apparatus according to an embodiment of the present disclosure.

FIG. 7 is an explanatory view showing an example of a correspondence table between telegram data and a process program in a substrate processing apparatus according to an embodiment of the present disclosure.

### DETAILED DESCRIPTION

### Embodiments

Embodiments of the present disclosure will now be described with reference to the drawings.

A substrate processing apparatus given as an example in the following embodiments is used in a process of manufacturing a semiconductor device and is configured to perform a predetermined process on a substrate to be processed. An example of the substrate to be processed may include a semiconductor wafer substrate (hereinafter, simply referred to as a “wafer”) in which a semiconductor integrated circuit device (semiconductor device) is built. When the term “wafer” is used in the present disclosure, it may refer to “a wafer itself” or “a laminated body (aggregate) of a wafer and certain layers or films formed on a surface of the wafer (that is, the wafer may include the certain layers or films formed on the surface of the wafer).” When the phrase “a surface of a wafer” is used in the present disclosure, it may refer to “a surface (an exposed surface) of a wafer itself” or “a surface of a certain layer, a film, and the like formed on a wafer, that is, an outermost surface of the wafer as a laminated body.” When the term “substrate” is used in the present disclosure, it may be synonymous with the term “wafer.” Examples of a process to perform on a wafer may include a transfer process, a pressurization (depressurization) process, a heating process, a film-forming process, an oxidation process, a diffusion process, reflow or annealing for carrier activation and flattening after ion implantation, and the like.

(1) Overall System Configuration

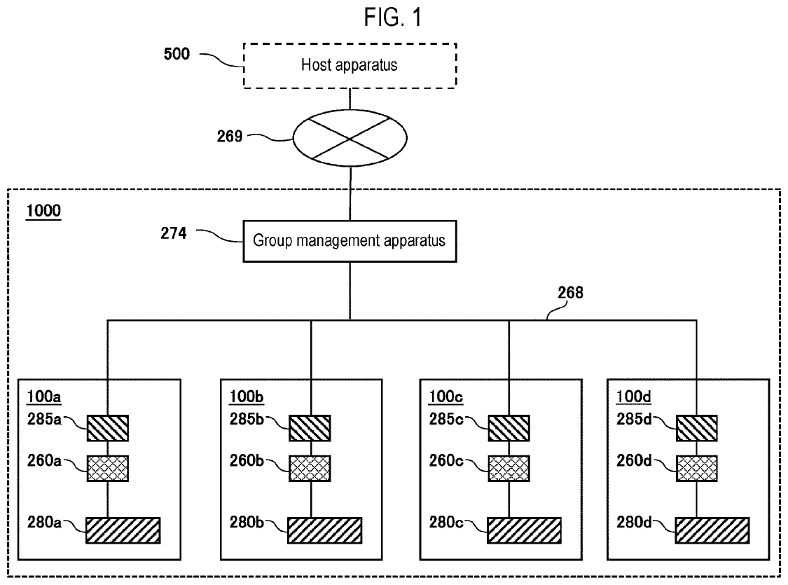

First, a configuration example of an entire system of a substrate processing apparatus according to an embodiment of the present disclosure will be described. FIG. 1 is a block diagram showing a schematic configuration example of the entire system of the substrate processing apparatus according to the present embodiment.

As shown in FIG. 1, an entire system 1000 of the substrate processing apparatus (hereinafter, simply referred to as a “substrate processing system”) to which the present disclosure is applied includes a plurality of substrate processing apparatuses 100a, 100b, 100c, and 100d. Further, the substrate processing system 1000 includes a group management apparatus 274 configured to manage the substrate processing apparatuses 100a, 100b, 100c, and 100d, and a LAN (Local Area Network) 268 which is an in-system network configured to connect the group management apparatus 274 and the substrate processing apparatuses 100a, 100b, 100c, and 100d. Although the case where four substrate processing apparatuses 100a, 100b, 100c, and 100d exist in the system is illustrated herein, at least one substrate processing apparatus may exist in the system, and the number thereof is not particularly limited.

A host apparatus (a host computer) 500, which is a higher-level device of the substrate processing system 1000, is connected to the group management apparatus 274 via an out-of-system network (for example, a wide area network such as the Internet) 269. Other electronic devices and substrate processing apparatuses (none of them is shown) or the like that does not constitute the substrate processing system 1000 may be connected to the out-of-system network 269.

Each of the substrate processing apparatuses 100a, 100b, 100c, and 100d constituting the substrate processing system 1000 is configured to process a wafer as a substrate. For the purpose of this, the substrate processing apparatuses 100a, 100b, 100c, and 100d include substrate processing units 280a, 280b, 280c, and 280d as processing parts (or processors) configured to process the wafer, controllers 260a, 260b, 260c, and 260d as control parts configured to control the processing, and transceivers 285a, 285b, 285c, and 285d connected to the group management apparatus 274 via the LAN 268 such that the transceivers 285a, 285b, 285c, and 285d can communicate with the group management apparatus 274, respectively.

In the following description, since the substrate processing apparatuses 100a, 100b, 100c, and 100d have the same configuration, they are collectively referred to as a substrate processing apparatus 100. The same applies to a substrate processing unit 280, a controller 260, and a transceiver 285.

(2) Configuration of Substrate Processing Unit

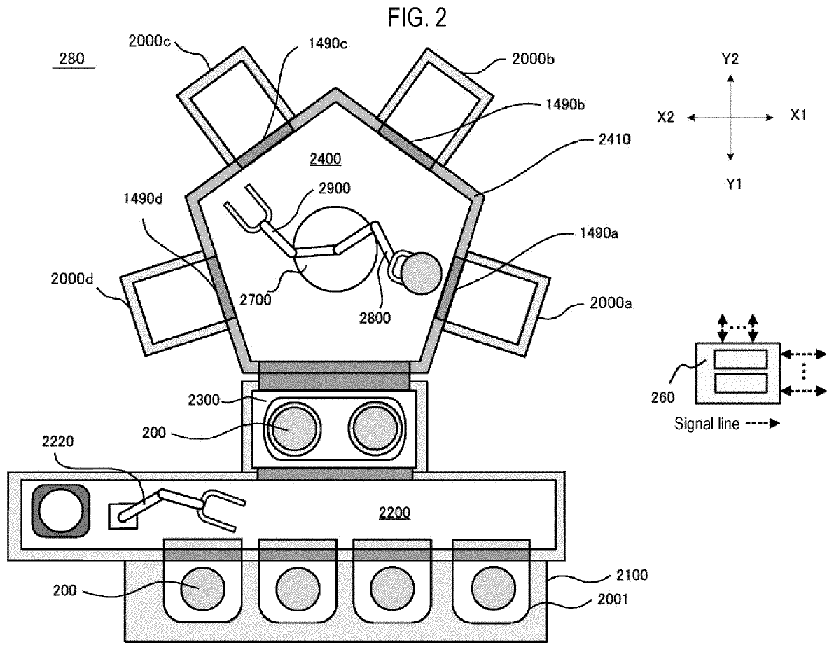

Subsequently, a configuration example of the substrate processing unit 280 in the substrate processing apparatus 100 will be described. The substrate processing unit 280 functions as a processor configured to process a wafer in a substrate processing process which is a process of manufacturing a semiconductor device. FIG. 2 is a schematic cross-sectional view showing the substrate processing unit according to the present embodiment.

As shown in FIG. 2, the substrate processing unit 280 to which the present disclosure is applied is configured to process a wafer 200 as a substrate and is of a so-called cluster type including a plurality of substrate processing modules 2000a, 2000b, 2000c, and 2000d. More specifically, the substrate processing unit 280 of the cluster type includes an IO stage 2100, an atmosphere transfer chamber 2200, a load lock (L/L) chamber 2300, a vacuum transfer chamber 2400, and the plurality of substrate processing modules 2000a, 2000b, 2000c, and 2000d. Since the substrate processing modules 2000a, 2000b, 2000c, and 2000d have the same configuration, they are collectively referred to as a substrate processing module 2000 in the following description. In the figure, it is assumed that an X1 direction is a right direction, an X2 direction is a left direction, a Y1 direction is a front direction, and a Y2 direction is a rear direction.

The IO stage (load port) 2100 is installed at the front side of the substrate processing unit 280. A plurality of storage containers (hereinafter, simply referred to as “pods”) 2001 called FOUPs (Front Open Unified Pods) are mounted on the IO stage 2100. The pods 2001 are used as carriers configured to transport the wafers 200 and are configured such that a plurality of unprocessed wafers 200 or processed wafers 200 are each stored in a horizontal posture in the pods 2001.

The IO stage 2100 is adjacent to the atmosphere transfer chamber 2200. An atmosphere transfer robot 2220 as a first transfer robot configured to transfer the wafer 200 is installed in the atmosphere transfer chamber 2200. The load lock chamber 2300 is connected to the atmosphere transfer chamber 2200 on a side different from that of the IO stage 2100.

An internal pressure of the load lock chamber 2300 is set to fluctuate according to a pressure of the atmosphere transfer chamber 2200 and a pressure of the vacuum transfer chamber 2400 to be described below and, for that purpose, configured to withstand a negative pressure. The vacuum transfer chamber (a transfer module: TM) 2400 is connected to the load lock chamber 2300 on a side different from that of the atmosphere transfer chamber 2200.

The TM 2400 functions as a transfer chamber that serves as a transfer space where the wafer 200 is transferred under the negative pressure. A housing 2410 constituting the TM 2400 has a pentagonal shape in a plane view, and a plurality of (for example, four) substrate processing modules 2000 configured to process the wafer 200 are respectively connected to sides of the pentagonal shape except a side of the pentagonal shape to which the load lock chamber 2300 is connected. A vacuum transfer robot 2700 as a second transfer robot configured to transfer (carry) the wafer 200 under the negative pressure is installed at substantially a central portion of the TM 2400. Although the vacuum transfer chamber 2400 is herein illustrated as the pentagonal shape, it may be a polygonal shape such as a quadrangular shape or a hexagonal shape.

The vacuum transfer robot 2700 installed in the TM 2400 includes two arms 2800 and 2900 that can operate independently of each other. The vacuum transfer robot 2700 is controlled by the controller 260 to be described below.

A gate valve (GV) 1490 is installed between the TM 2400 and each substrate processing module 2000. Specifically, a gate valve 1490a is installed between the substrate processing module 2000a and the TM 2400, and a GV 1490b is installed between the substrate processing module 2000b and the TM 2400. A GV 1490c is installed between the substrate processing module 2000c and the TM 2400, and a GV 1490d is installed between the substrate processing module 2000d and the TM 2400. When each GV1490 is opened, the vacuum transfer robot 2700 in the TM 2400 can take in and out the wafer 200 via a substrate loading/unloading port 1480 installed at each substrate processing module 2000.

(3) Configuration of Substrate Processing Module

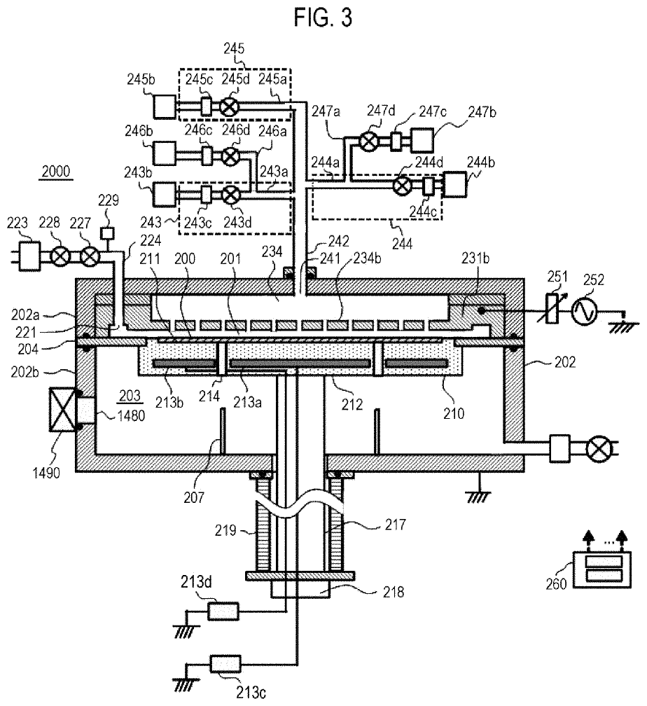

Subsequently, a configuration example of the substrate processing module 2000 in the substrate processing unit 280 will be described. The substrate processing module 2000 is configured to execute a substrate processing process which is a process of manufacturing a semiconductor device, and more specifically, performs, for example, a film-forming process as a process to perform on a wafer. Here, as the substrate processing module 2000 configured to perform the film-forming process, a module configured as a single-wafer type substrate processing apparatus will be given as an example. FIG. 3 is a schematic configuration view showing a substrate processing module according to the present embodiment.

(Process Container)

As shown in FIG. 3, the substrate processing module 2000 includes a process container 202. The process container 202 is made of, for example, a metal material such as aluminum (Al) or stainless steel (SUS), or quartz and is configured as a flat closed container having a circular cross section. Further, the process container 202 includes an upper container 202a and a lower container 202b, and a partition portion 204 is provided therebetween. A space surrounded by the upper container 202a above the partition portion 204 functions as a process space (also referred to as a “process chamber”) 201 configured to process the wafer 200 to be processed in the film-forming process. On the other hand, a space surrounded by the lower container 202b below the partition portion 204 functions as a transfer space (also referred to as a “transfer chamber”) 203 where the wafer 200 is transferred. the substrate loading/unloading port 1480 adjacent to the gate valve 1490 is installed at the side surface of the lower container 202b such that the space surrounded by the lower container 202b below the partition portion 204 functions as the transfer chamber 203, and the wafer 200 is moved to and from an outside (for example, the TM 2400 adjacent to the transfer chamber 203) via the substrate loading/unloading port 1480. A plurality of lift pins 207 are installed at the bottom of the lower container 202b. Further, the lower container 202b is grounded.

(Substrate Support)

A substrate support (susceptor) 210 configured to support the wafer 200 is installed in the process chamber 201. The susceptor 210 includes a substrate mounting stage 212 having a mounting surface 211 on which the wafer 200 is mounted. The substrate mounting stage 212 includes therein at least heaters 213a and 213b configured to adjust (heat or cool) a temperature of the wafer 200 on the mounting surface 211. Temperature regulating parts 213c and 213d configured to regulate power supplied to the respective heaters 213a and 213b are individually connected to the heaters 213a and 213b. The temperature regulating parts 213c and 213d are independently controlled according to an instruction from the controller 260 to be described below. As a result, the heaters 213a and 213b are configured to be capable of performing a zone control to independently regulate the temperature of the wafer 200 on the mounting surface 211 for each zone. Further, the substrate mounting stage 212 is provided with through-holes 214 through which the lift pins 207 penetrate, at positions corresponding to the lift pins 207.

The substrate mounting stage 212 is supported by a shaft 217. The shaft 217 penetrates the bottom of the process container 202 and is further connected to an elevating mechanism 218 outside the process container 202. Then, by operating the elevating mechanism 218, the substrate mounting stage 212 can be moved up or down. A periphery of a lower end of the shaft 217 is covered with a bellows 219, and an interior of the process chamber 201 is kept airtight.

The substrate mounting stage 212 lowers so that the substrate mounting surface 211 is at a position of the substrate loading/unloading port 1480 (a wafer transfer position) when the wafer 200 is transferred, and rises so that the wafer 200 rises to a process position in the process chamber 201 (a wafer process position) when the wafer 200 is processed. Specifically, when the substrate mounting stage 212 is lowered to the wafer transfer position, upper end portions of the lift pins 207 protrude from an upper surface of the substrate mounting surface 211 such that the lift pins 207 support the wafer 200 from below. Further, when the substrate mounting stage 212 is raised to the wafer process position, the lift pins 207 are buried from the upper surface of the substrate mounting surface 211 such that the substrate mounting surface 211 supports the wafer 200 from below. Since the lift pins 207 come into a direct contact with the wafer 200, the lift pins 207 may be made of a material such as quartz or alumina.

(Gas Introduction Port)

A gas introduction port 241 configured to supply various kinds of gases into the process chamber 201 is installed at an upper portion of the process chamber 201. A configuration of gas supply units connected to the gas introduction port 241 is described below.

A shower head (a buffer chamber) 234 including a dispersion plate 234b may be disposed in the process chamber 201 communicating with the gas introduction port 241 to disperse a gas supplied from the gas introduction port 241 and evenly diffuse the gas in the process chamber 201.

A matching device 251 and a high-frequency power supply 252 are connected to a support member 231b of the dispersion plate 234b such that electromagnetic waves (high-frequency power and microwaves) can be supplied. As a result, the gas supplied into the process chamber 201 via the dispersion plate 234b can be excited into plasma. That is, the dispersion plate 234b, the support member 231b, the matching device 251, and the high-frequency power supply 252 are configured to convert a first process gas and a second process gas to be described below into plasma, and function as a part of a first gas supply part (details of which are described below) and a part of a second gas supply part (details of which are described below) configured to supply the gas converted into plasma.

(Gas Supply Part)

A common gas supply pipe 242 is connected to the gas introduction port 241. A first gas supply pipe 243a, a second gas supply pipe 244a, and a third gas supply pipe 245a are connected to the common gas supply pipe 242. The first process gas (details of which are described below) is mainly supplied from the first gas supply part 243 including the first gas supply pipe 243a, and the second process gas (details of which are described below) is mainly supplied from the second gas supply part 244 including the second gas supply pipe 244a. A purge gas is mainly supplied from a third gas supply part 245 including the third gas supply pipe 245a.

(First Gas Supply Part)

A first gas supply source 243b, a mass flow controller (MFC) 243c, which is a flow rate controller (a flow rate control part), and a valve 243d, which is an opening/closing valve, are installed at the first gas supply pipe 243a sequentially from the corresponding upstream side. Then, a gas containing a first element (a first process gas) is supplied from the first gas supply source 243b into the process chamber 201 via the MFC 243c, the valve 243d, the first gas supply pipe 243a, and the common gas supply pipe 242.

The first process gas is, for example, a gas containing a silicon (Si) element. Specifically, a dichlorosilane (SiH₂Cl₂, abbreviation: DCS) gas, a tetraethoxysilane (Si(OC₂H₅)₄, abbreviation: TEOS) gas, or the like is used as the first process gas. In the following description, an example using the DCS gas will be described.

The downstream end of a first inert gas supply pipe 246a is connected to the downstream side of the valve 243d of the first gas supply pipe 243a. An inert gas supply source 246b, an MFC 246c, and a valve 246d are installed at the first inert gas supply pipe 246a sequentially from the corresponding upstream side. Then, an inert gas is supplied from the inert gas supply source 246b to the first gas supply pipe 243a via the MFC 246c and the valve 246d. The inert gas is, for example, a nitrogen (N₂) gas. As the inert gas, in addition to the N₂ gas, a rare gas such as an argon (Ar) gas, a helium (He) gas, a neon (Ne) gas, a xenon (Xe) gas, or the like can be used.

The first gas supply part (also referred to as a Si-containing gas supply part) 243, which is one of the process gas supply parts, mainly includes the first gas supply pipe 243a, the MFC 243c, and the valve 243d. The first gas supply part 243 may include the first gas supply source 243b. A first inert gas supply part mainly includes the first inert gas supply pipe 246a, the MFC 246c, and the valve 246d. The first inert gas supply part may include the inert gas supply source 246b and the first gas supply pipe 243a. Further, the first gas supply part 243 may include the first inert gas supply part.

(Second Gas Supply Part)

A second gas supply source 244b, an MFC 244c, and a valve 244d are installed at the second gas supply pipe 244a sequentially from the corresponding upstream side. Then, a gas containing a second element (a second process gas) is supplied from the second gas supply source 244b into the process chamber 201 via the MFC 244c, the valve 244d, the second gas supply pipe 244a, and the common gas supply pipe 242.

The second process gas contains a second element (for example, nitrogen) different from the first element (for example, Si) contained in the first process gas and is, for example, a nitrogen (N)-containing gas. As the N-containing gas, for example, an ammonia (NH₃) gas is used.

The downstream end of a second inert gas supply pipe 247a is connected to the downstream side of the valve 244d of the second gas supply pipe 244a. An inert gas supply source 247b, an MFC 247c, and a valve 247d are installed at the second inert gas supply pipe 247a sequentially from the corresponding upstream side. Then, an inert gas is supplied from the inert gas supply source 247b to the second gas supply pipe 244a via the MFC 247c and the valve 247d. The inert gas is the same as that in the case of the first inert gas supply part.

The second gas supply part (also referred to as an oxygen-containing gas supply part) 244, which is another one of the process gas supply parts, mainly includes the second gas supply pipe 244a, the MFC 244c, and the valve 244d. The second gas supply part 244 may include the second gas supply source 244b. A second inert gas supply part mainly includes the second inert gas supply pipe 247a, the MFC 247c, and the valve 247d. The second inert gas supply part may include the inert gas supply source 247b and the second gas supply pipe 244a. Further, the second gas supply part 244 may include the second inert gas supply part.

(Third Gas Supply Part)

A third gas supply source 245b, an MFC 245c, and a valve 245d are installed at the third gas supply pipe 245a sequentially from the corresponding upstream side. Then, an inert gas as a purge gas is supplied from the third gas supply source 245b into the process chamber 201 via the MFC 245c, the valve 245d, the third gas supply pipe 245a, and the common gas supply pipe 242.

Here, the inert gas is, for example, a N₂ gas. As the inert gas, in addition to the N₂ gas, a rare gas such as an Ar gas, a He gas, a Ne gas, a Xe gas, or the like can be used.

The third gas supply part (also referred to as a purge gas supply part) 245, which is an inert gas supply part, mainly includes the third gas supply pipe 245a, the MFC 245c, and the valve 245d. The third gas supply part 245 may include the third gas supply source 245b.

(Exhaust Part)

An exhaust port 221 configured to exhaust an atmosphere in the process chamber 201 (the upper container 202a) is installed at an upper surface of an inner wall of the process chamber 201. An exhaust pipe 224 as a first exhaust pipe is connected to the exhaust port 221. At the exhaust pipe 224, a pressure regulator 227 such as an APC (Auto Pressure Controller) configured to control a pressure of the interior of the process chamber 201 to be a predetermined pressure, an exhaust regulating valve 228 as an exhaust regulating part installed at the front stage or the rear stage of the pressure regulator 227, and a vacuum pump 223 are connected in series.

The pressure regulator 227 and the exhaust regulating valve 228 are configured to regulate an internal pressure of the process chamber 201, while following the control by the controller 260, which is described below, when the substrate processing step to be described below is performed. More specifically, the pressure regulator 227 and the exhaust regulating valve 228 are configured to regulate the internal pressure of the process chamber 201 by varying a degree of opening of valves in the pressure regulator 227 and the exhaust regulating valve 228 according to a process recipe in which the procedures and conditions of substrate processing are described.

Further, at the exhaust pipe 224, a pressure sensor 229 as a pressure measuring part configured to measure the internal pressure of the exhaust pipe 224, is installed, for example at the front stage (that is, a side close to the process chamber 201) of the pressure regulator 227. Although the case where the pressure sensor 229 measures the internal pressure of the exhaust pipe 224 is taken as an example herein, the pressure sensor 229 may measure the internal pressure of the process chamber 201. That is, the pressure sensor 229 may measure the internal pressure of either the process chamber 201 or the exhaust pipe 224 constituting the exhaust part.

The exhaust part (exhaust line) mainly includes the exhaust port 221, the exhaust pipe 224, the pressure regulator 227, and the exhaust regulating valve 228. The exhaust part may include the vacuum pump 223 and the pressure sensor 229.

(4) Configuration of Controller

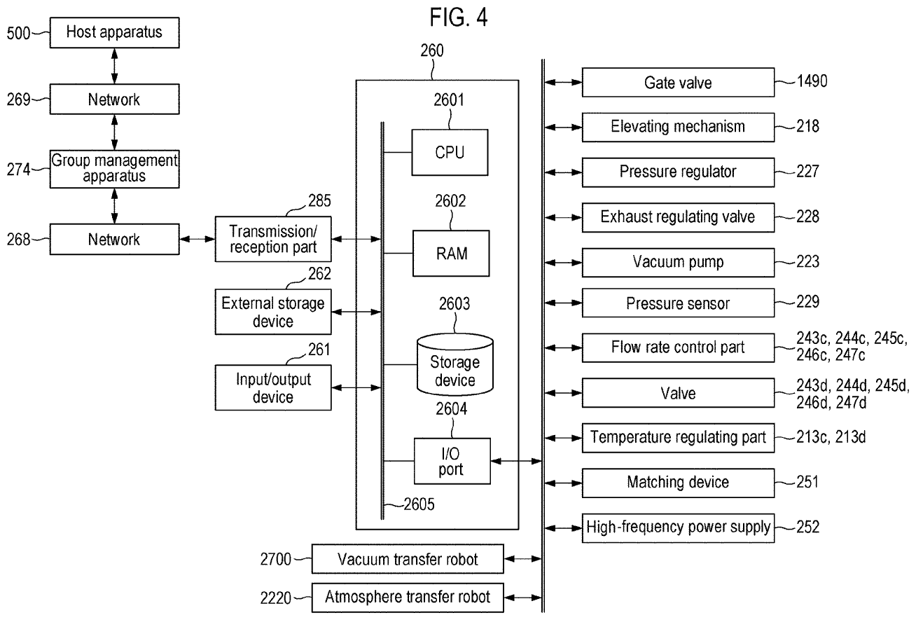

Next, a configuration example of the controller 260 in the substrate processing apparatus 100 will be described. The controller 260 is configured to control the processing operation of the substrate processing unit 280 including the above-mentioned substrate processing module 2000. FIG. 4 is a block diagram showing the controller according to the present embodiment.

(Hardware Configuration)

The controller 260 functions as a controller (control means) configured to control the operation of the substrate processing unit 280. Therefore, as shown in FIG. 4, the controller 260 is configured as a computer including a CPU (Central Processing Unit) 2601, a RAM (Random Access Memory) 2602, a storage device 2603, and an I/O port 2604. The RAM 2602, the storage device 2603, and the I/O port 2604 are configured to exchange data with the CPU 2601 via an internal bus 2605.

The storage device 2603 includes, for example, a flash memory, an HDD (Hard Disk Drive), or the like. A control program that controls the operation of the substrate processing unit 280, a process recipe in which the procedures and conditions of substrate processing are written, arithmetic data and processing data generated in the course of various processes, and the like can be readably stored in the storage device 2603. The process recipe functions as a program combined to cause the controller 260 to execute each procedure in the substrate processing to obtain an expected result. That is, the storage device 2603 has a function as a program memory configured to store a program. The storage device 2603 also has a function as a table memory configured to store table data to be described in detail below.

The RAM 2602 is configured as a memory area (work area) in which the program, arithmetic data, processing data, and the like read by the CPU 2601 are temporarily held.

The I/O port 2604 is connected with the gate valve 1490, the elevating mechanism 218, the pressure regulator 227, the exhaust regulating valve 228, the vacuum pump 223, the pressure sensor 229, the MFC 243c, 244c, 245c, 246c, and 247c, the valves 243d, 244d, 245d, 246d, and 247d, the temperature regulating parts 213c and 213d, the matching device 251, the high-frequency power supply 252, the vacuum transfer robot 2700, the atmosphere transfer robot 2220, and the like.

Further, the controller 260 is configured so that an input/output device 261 configured as, for example, a touch panel or the like and an external storage device 262 can be connected to the controller 260. Further, the controller 260 is configured so that the group management apparatus 274 can be connected via the transceiver 285 and the LAN 268. The connection in the present disclosure also includes a meaning that each part is connected by a physical cable (signal line), but also includes a meaning that signals (electronic data) of each part can be directly or indirectly transmitted/received.

(Program)

The control program, process recipe, and the like stored in the storage device 2603 function as a program executed by the CPU 2601 as an arithmetic part. Hereinafter, these are generally and simply referred to as a program or a recipe. When the term “program” is used in the present disclosure, it may indicate a case of including the program only, a case of including the recipe only, or a case of including a combination thereof.

The CPU 2601 as the arithmetic part is configured to read out and execute the program from the storage device 2603. Then, the CPU 2601 performs the opening/closing of the gate valve 1490, the moving up/down operation of the elevating mechanism 218, the supply of power of the temperature regulating parts 213c and 213d, the matching operation of power of the matching device 251, the on/off control of the high-frequency power supply 252, the operation control of the MFC 243c, 244c, 245c, 246c, and 247c, the on/off control of gas of the valves 243d, 244d, 245d, 246d, 247d, and 308, the regulation of degree of valve opening of the pressure regulator 227, the regulation of degree of valve opening of the exhaust regulating valve 228, the on/off control of the vacuum pump, the operation control of the vacuum transfer robot 2700, the operation control of the atmosphere transfer robot 2220, and on the like according to contents prescribed in the read program.

The controller 260 is not limited to a case where it is configured as a dedicated computer, but may be configured as a general-purpose computer. For example, the controller 260 according to the present embodiment can be configured by providing an external storage device (for example, a magnetic tape, a magnetic disk such as a flexible disk or a hard disk, an optical disc such as a CD or DVD, a magneto-optical disc such as an MO, a semiconductor memory such as a USB memory or a memory card) 262 that stores the above-mentioned program and installing the program on the general-purpose computer by using the external storage device 262. However, the means to supply the program to the computer is not limited to the case of supplying the program via the external storage device 262. For example, another communication means may be used to supply the program without going via the external storage device 262. The storage device 2603 and the external storage device 262 are configured as a computer-readable recording medium. Hereinafter, these are generally referred to simply as a recording medium. In the present disclosure, when the term “recording medium” is used, it may include the storage device 2603 alone, the external storage device 262 alone, or both.

(5) Basic Procedure of Substrate Processing Process

Next, as a process of manufacturing a semiconductor device, a substrate processing process of forming a predetermined film on a wafer 200 is taken as an example, and the outline thereof will be described. Here, a case where a silicon nitride film (SiN film) as a nitride film is formed as the predetermined film is taken as an example. The substrate processing process to be described below is performed by the substrate processing unit 280 in the above-described substrate processing apparatus 100. Further, in the following description, the operation of each part is controlled by the controller 260.

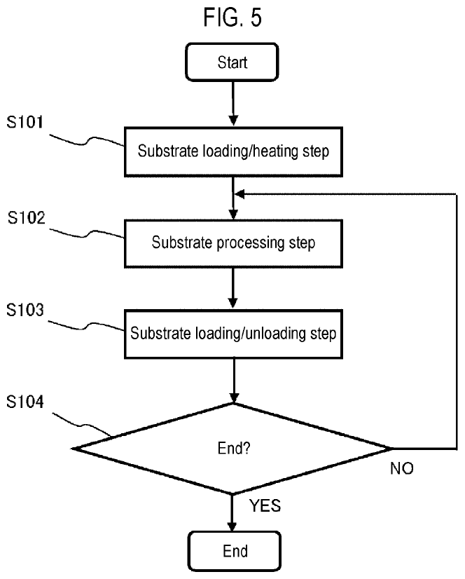

FIG. 5 is a flow chart of the outline of the substrate processing process according to the present embodiment.

(Substrate Loading/Heating Step: S101)

In substrate processing, first, in a substrate loading/heating step (S101), an unprocessed wafer 200 is taken out from the pod 2001 on the 10 stage 2100, and the wafer 200 is loaded into the substrate processing module 2000. When a plurality of substrate processing modules 2000 exist, the wafer 200 is loaded into the respective substrate processing modules 2000 in a predetermined order. The wafer 200 is taken out by using the atmosphere transfer robot 2220 in the atmosphere transfer chamber 2200. Further, the wafer 200 is loaded in by using the vacuum transfer robot 2700 in the TM 2400. Then, when the wafer 200 is loaded in, the vacuum transfer robot 2700 is retracted, and the gate valve 1490 is closed to seal the interior of the process container 202 of the substrate processing module 2000. Thereafter, the substrate mounting stage 212 is raised to position the wafer 200 on the mounting surface 211 at the wafer process position. In this state, the exhaust part (exhaust system) is controlled so that the internal pressure of the process chamber 201 becomes a predetermined pressure, and the heaters 213a and 213b are controlled so that the surface temperature of the wafer 200 becomes a predetermined temperature.

(Substrate Processing Step: S102)

When the wafer 200 located at the wafer process position reaches a predetermined temperature, a substrate processing step (S102) is subsequently performed. In the substrate processing step (S102), while the wafer 200 is heated to a predetermined temperature, the first gas supply part 243 is controlled to supply the first process gas to the process chamber 201, and the exhaust part is controlled to exhaust the process chamber 201 to process the wafer 200. At this time, the second gas supply part 244 may be controlled so that the second process gas exists at the same time with the first process gas in the process space to perform a CVD process, or the first process gas and the second process gas are supplied alternately to perform a cyclic process. Further, when the second process gas is processed in a plasma state, plasma may be generated in the process chamber 201 by supplying high-frequency power to the dispersion plate 234b.

The following method may be considered as a cyclic process which is a specific example of a film-processing method. For example, a case where a DCS gas is used as the first process gas and a NH₃ gas is used as the second process gas can be considered. In this case, the DCS gas is supplied to the wafer 200 in a first step, and the NH₃ gas is supplied to the wafer 200 in a second step. As a purge step between the first step and the second step, a N₂ gas is supplied and the atmosphere of the process chamber 201 is exhausted. A silicon nitride (SiN) film is formed on the wafer 200 by performing a cyclic process in which the first step, the purge step, and the second step are performed a plurality of times.

(Substrate Loading/Unloading Step: S103)

After a predetermined process is performed on the wafer 200, the processed wafer 200 is unloaded from the inside of the process container 202 of the substrate processing module 2000 in the substrate loading/unloading step (S103). The processed wafer 200 is unloaded, for example by using the arm 2900 of the vacuum transfer robot 2700 in the TM 2400.

At this time, for example, when the unprocessed wafer 200 is held by the arm 2800 of the vacuum transfer robot 2700, the vacuum transfer robot 2700 loads the unprocessed wafer 200 into the process container 202. Then, the substrate processing step (S102) is performed on the wafer 200 in the process container 202. When the unprocessed wafer 200 is not held by the arm 2800, the processed wafer 200 is only unloaded.

When the vacuum transfer robot 2700 unloads the wafer 200, the processed wafer 200 that has been unloaded is then accommodated in the pod 2001 on the IO stage 2100. The wafer 200 is accommodated in the pod 2001 by using the atmosphere transfer robot 2220 in the atmosphere transfer chamber 2200.

(Determination Step: S104)

In the substrate processing apparatus 100, the substrate processing step (S102) and the substrate loading/unloading step (S103) are repeatedly performed until there are no unprocessed wafers 200. Then, when there are no unprocessed wafers 200, the series of processes (S101 to S104) described above are completed.

(6) Remote Control of Substrate Processing Apparatus

Next, a remote control of the substrate processing apparatus 100 that performs the series of processes described above will be described.

(Overview of Remote Control)

The series of processes described above is controlled by the controller 260. The contents of control by the controller 260 are prescribed by a control program, a process recipe, or the like read from the storage device 2603 (hereinafter, these are generally referred to as a “process program”). That is, the series of process procedures, process conditions, and the like described above are prescribed by the process program in the storage device 2603.

In that case, when the host apparatus 500 connected to the substrate processing apparatus 100 via a network gives instructions regarding the execution of the process program, the remote control of the substrate processing apparatus 100 can be realized.

However, in the case where the remote control of the substrate processing apparatus 100 is performed, when an unspecified number of electronic apparatuses and the like are present on a network connected to the substrate processing apparatus 100, it is difficult to completely eliminate a risk of virus infection on the substrate processing apparatus 100. When the controller 260 of the substrate processing apparatus 100 is infected with a virus, the substrate processing apparatus 100 requires a maintenance work for removing the virus, which impairs the operation of the apparatus, and as a result, the throughput of substrate processing may be adversely affected.

From this, in the present embodiment, as shown in FIG. 1, the substrate processing system 1000 includes the group management apparatus 274 between the substrate processing apparatus 100 and the host apparatus 500. Then, with the group management apparatus 274 as a gate, the LAN 268, which is an in-system network on the substrate processing apparatus 100 side, and the out-of-system network 269 on the host apparatus 500 side are configured to be completely independent from one another.

(Group Management Device)

The group management apparatus 274, which is configured by, for example, a computer device, is disposed between the substrate processing apparatus 100 and the host apparatus 500, and is configured to bridge data between them.

The host apparatus 500 is connected to the group management apparatus 274 via the out-of-system network 269. Then, data can be transmitted and received to and from the host apparatus 500 constantly by using a plurality of types of communication protocols (that is, a plurality of protocols). That is, the group management apparatus 274 is connected to the host apparatus 500 capable of communicating with a plurality of protocols. As a result, the group management apparatus 274 can provide a host interface for remote control of the substrate processing apparatus 100.

On the other hand, the substrate processing apparatus 100 is connected to the group management apparatus 274 via the LAN268. Then, only data of a telegram format (hereinafter, also simply referred to as “telegram data”) are transmitted and received to and from the substrate processing apparatus 100. That is, the group management apparatus 274 is configured to receive a plurality of types of data including the telegram data from the host apparatus 500 and transmit only the telegram data among the plurality of types of data to the transceiver 285 of the substrate processing apparatus 100.

Here, the “telegram data” refers to a set of data described according to a predetermined telegram format and exchanged between computers. Further, “only” the telegram data mean that data in any format other than the telegram data are not exchanged at all.

Specifically, the group management apparatus 274 is configured to conduct communication corresponding to, for example, an HSMS (High Speed Message Service) format of an SEMI (Semiconductor Equipment and Material Institute) E37 with the transceiver 285 of the substrate processing apparatus 100. The HSMS is a communication interface that transmits and receives message-structured telegram data.

Here, as the communication interface that transmits and receives only the telegram data, the HSMS format is taken as an example, but the present disclosure is not necessarily limited thereto. Any other formats may be used as long as only the telegram data can be transmitted and received.

(Transceiver of Substrate Processing Apparatus)

The substrate processing apparatus 100 includes the transceiver 285 to communicate with the group management apparatus 274 as described above. The transceiver 285 is configured to be capable of communicating with only the group management apparatus 274 via the LAN 268. The presence of such a transceiver 285 enables the controller 260 to exchange data with the group management apparatus 274.

As described above, the group management apparatus 274 transmits only the telegram data to the substrate processing apparatus 100. Therefore, the transceiver 285 is connected to the group management apparatus 274 so that the transceiver 285 can communicate with the group management apparatus 274, and configured to transmit and receive only the telegram data to and from the group management apparatus 274. The meanings of “telegram data” and “only” are as described above.

Specifically, the transceiver 285 is configured to conduct communication corresponding to the HSMS format, similarly to the group management apparatus 274. However, the present disclosure is not necessarily limited thereto, but any other formats may be used as long as only the telegram data can be transmitted and received.

(Telegram Data)

Here, the telegram data transmitted and received between the group management apparatus 274 and the transceiver 285 of the substrate processing apparatus 100 will be described with a specific example.

The telegram data has a message structure including a header and a data part (body), for example, in the HSMS format. Of these, in a section of the data part, a command statement (instruction data) corresponding to an instruction to the substrate processing apparatus 100 is described. Specifically, for example, a command statement to select a process program to be executed by the controller 260 of the substrate processing apparatus 100 is described in the section of the data part of the telegram data.

Such telegram data includes, for example, text data. The text data refer to data including only character codes (for example, ASCII, Shift JIS, and the like).

Further, the telegram data may have a message structure including a message length (length byte), for example like the HSMS format.

Further, the telegram data may be configured to include a parity, a checksum value, and a code for checking. In the present disclosure, the parity, the checksum value, and the code for checking are used when at least one selected from the group of parity check, checksum, CRC (Cyclic Redundancy Check), and the like to be described below is performed.

Further, size data specifying the data size (file size) of the telegram data is described in a section of the message length of the telegram data. That is, the telegram data may include the size data of the telegram data.

Further, the telegram data may be configured to have a predetermined size. Specifically, the telegram data may be configured to have data size matching one of predetermined size frames. For example, the data size of the telegram data is m bytes, n bytes, and so on (m and n are natural numbers).

As described above, in the present embodiment, the LAN 268 and the out-of-system network 269 are completely independent from each other via the group management apparatus 274, and only telegram data are transmitted and received between the group management apparatus 274 and the transceiver 285 of the substrate processing apparatus 100 via the LAN 268. Since the telegram data is the data described according to a predetermined telegram format as described above, a possibility that unjustified information (for example, a virus) may be mixed in is extremely low. Therefore, when the communication between the group management apparatus 274 and the substrate processing apparatus 100 is limited to the telegram data, even in a case where there is a virus infection from the out-of-system network 269, it is possible to eliminate a risk that the substrate processing apparatus 100 may be infected with the virus. The out-of-system network 269 may be connected to a public network. In this case, the risk of virus infection also increases, but according to the technique of the present disclosure, it is possible to eliminate the risk that the substrate processing apparatus 100 may be infected with the virus.

(Data Transmission/Reception Process)

Next, a telegram data transmission/reception process performed between the group management apparatus 274 and the substrate processing apparatus 100 will be described.

Data of a plurality of protocols is sent from the host apparatus 500 to the group management apparatus 274 via the out-of-system network 269 are transmitted. The group management apparatus 274 transmits only the telegram data among those data to the transceiver 285 of the substrate processing apparatus 100 via the LAN 268.

When the transceiver 285 receives the telegram data from the group management apparatus 274, the controller 260 checks the telegram data. That is, the controller 260 has a function of checking the telegram data received by the transceiver 285, and is configured to determine whether or not the telegram data is error data.

Specifically, the controller 260 checks a size capacity (a file size) of the telegram data. The size capacity is checked by using the table data that records the size capacity of the telegram data.

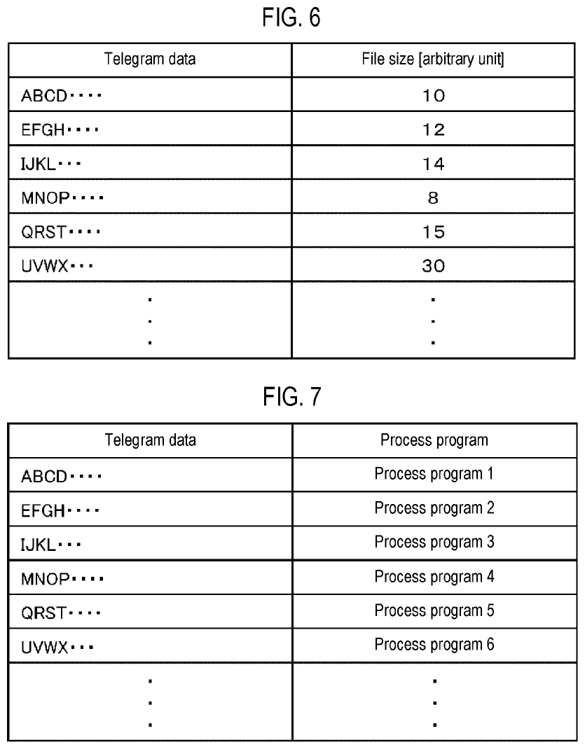

FIG. 6 is an explanatory view showing an example of table data of a telegram data size in the substrate processing apparatus according to the present embodiment. As shown in FIG. 6, the table data is a record of the telegram data and the size capacity (file size) of the telegram data in association with each other. It is assumed that the table data is set in advance and is readably stored in the storage device 2603 that functions as a table memory.

While using such table data, the controller 260 checks the size capacity of the telegram data according to the procedure to be described below. When the transceiver 285 receives the telegram data, it first recognizes the data size (file size) of the telegram data. For example, in a case where the received telegram data includes size data, the data size is recognized based on the size data. However, the data size may be recognized by measuring the data size of the telegram data each time the telegram data are received. On the other hand, when the transceiver 285 receives the telegram data, it accesses the table data in the storage device 2603 and reads out the size capacity (file size) corresponding to the received telegram data. Then, for the received telegram data, a data size recognition result is compared with the size capacity recorded in the table data to determine whether or not they match.

When it is determined that they do not match, the received telegram data does not have the original (justified) size, and it is suspected that some unjustified information (for example, a virus) is mixed in. Therefore, the controller 260 regards such a determination result for the telegram data as an error. Then, an instruction is given to the transceiver 285 to transmit the telegram data determined to have the error (that is, the error data) to the group management apparatus 274 as it is without receiving and processing the error data. This makes it possible to completely eliminate the risk of virus infection on the substrate processing apparatus 100.

It should be noted that in addition to the above-mentioned checking method, at least one selected from the group of the above-mentioned parity, checksum value, and code for checking may be used to execute any one of parity check, checksum, and CRC. It is possible to make a determination based on the result obtained by such a check.

At this time, the controller 260 may output an alarm, which indicates that the check result for the telegram data is an error, to the group management apparatus 274 or the host apparatus 500.

On the other hand, when it is determined that the data size recognition result matches the size capacity recorded in the table data, the received telegram data has the original (justified) size. Thus, the controller 260 performs a program execution process to be described in detail below based on the telegram data.

Here, the case where the check for the telegram data is performed by using the table data in the storage device 2603 is given as an example, but the present disclosure is not limited thereto, and checks by other methods may also be performed. For example, in the case where the telegram data includes size data, the telegram data may be checked by determining whether or not the measurement result of the data size of the telegram data matches the size data. Further, for example, in the case where the telegram data is configured to have a predetermined size, the telegram data that does not match a predetermined size frame may be determined to be an error.

(Program Execution Process)

Next, a program execution process in the substrate processing apparatus 100 based on the received telegram data will be described.

In the case where the telegram data received from the group management apparatus 274 is not an error, the controller 260 recognizes contents of the command statement (instruction data) described in the section of the data part of the telegram data.

Upon recognizing the contents of the command statement in the telegram data, subsequently, the controller 260 selectively reads out a process program corresponding to the recognized contents of the command statement among a plurality of types of process programs (hereinafter, also referred to as a “process program group”) stored in the storage device 2603 that functions as the program memory. The determination of the corresponding process program may be performed, for example based on the contents of a correspondence table attached to the process program group and stored in the storage device 2603.

FIG. 7 is an explanatory diagram showing an example of the correspondence table between the telegram data and the process program in the substrate processing apparatus according to the present embodiment. The correspondence table is a table in which each process program constituting the process program group and the command statement of the telegram data instructing the execution of the process program are recorded in association with each other. For example, according to the correspondence table shown in FIG. 7, it can be seen that a command statement of the telegram data “ABCD . . . ” corresponds to “process program 1,” a command statement of the telegram data “EFGH . . . ” corresponds to “process program 2,” and a command statement of the telegram data “IJKL . . . ” corresponds to “process program 3.” The process programs 1, 2, 3, . . . are stored in advance in the storage device 2603 as the program memory, and the process programs each prescribe processing operations according to different types of process procedures, process conditions, or the like.

By referring to such a correspondence table, even when the transceiver 285 receives only the telegram data, the controller 260 can specify a process program that matches the command statement of the telegram data, and can selectively read out the specified process program from the process program group in the storage device 2603. It is assumed that the corresponding table is set in advance and is readably stored in the storage device 2603 that functions as the program memory.

When the process program corresponding to the received telegram data is selectively read out from the process program group in the storage device 2603, the CPU 2601 in the controller 260 executes the process program thus read out. Then, the CPU 2601 controls the processing operation performed by the substrate processing unit 280 that functions as a processing part to conform to the contents prescribed by the read-out process program.

Specifically, the CPU 2601 executes the process program to perform, for example, the opening/closing of the gate valve 1490 constituting the substrate processing module 2000 in the substrate processing unit 280, the moving up/down operation of the elevating mechanism 218, the supply of power of the temperature regulating parts 213c and 213d, the matching operation of power of the matching device 251, the on/off control of the high-frequency power supply 252, the operation control of the MFC 243c, 244c, 245c, 246c, and 247c, the on/off control of gas of the valves 243d, 244d, 245d, 246d, 247d, and 308, the regulation of degree of valve opening of the pressure regulator 227, the regulation of degree of valve opening of the exhaust regulating valve 228, the on/off control of the vacuum pump, the operation control of the vacuum transfer robot 2700 and the atmosphere transfer robot 2220 constituting the substrate processing unit 280, and the like.

That is, the controller 260 controls the processing operation performed by the substrate processing unit 280 that functions as the processing part, by executing the process program corresponding to the telegram data, based on the telegram data received by the transceiver 285.

When the controller 260 performs such a program execution process, it is possible to realize a remote control using the telegram data exchanged via the group management apparatus 274 for the processing operation in the substrate processing apparatus 100. Moreover, even in that case, since only the telegram data are exchanged between the group management apparatus 274 and the substrate processing apparatus 100, it is possible to eliminate the risk of virus infection on the substrate processing apparatus 100.

(7) Effects of the Embodiments

According to the embodiments of the present disclosure, one or more effects set forth below may be achieved.

(a) In the embodiments, only the telegram data is transmitted and received between the group management apparatus 274 and the substrate processing apparatus 100, and the process performed by the substrate processing unit 280 of the substrate processing apparatus 100 is controlled based on the telegram data. Therefore, when the substrate processing apparatus 100 is remotely controlled, even in the case where there is a virus infection from the out-of-system network 269, it is possible to eliminate the risk that the virus may infect the substrate processing apparatus 100.

That is, according to the embodiments, by transmitting and receiving only the telegram data, it is possible to eliminate the risk of virus infection from the out-of-system network 269, which prevents operation of the apparatus from being impaired due to maintenance work for virus removal, and the like in advance. As a result, the throughput of the substrate processing in the substrate processing apparatus 100 can be improved.

(b) In the embodiments, the controller 260 has the function of checking the telegram data received from the group management apparatus 274. Therefore, it is possible to eliminate the error data by determining whether or not the received telegram data are the error data, which makes it possible to completely eliminate the risk of virus infection on the substrate processing apparatus 100.

(c) In the embodiments, the size capacity (file size) of the telegram data received from the group management apparatus 274 is checked while using the table data stored in the storage device 2603. Therefore, it is possible to easily and accurately determine whether or not the received telegram data is the error data. This leads to simplification of the determination process by the checking function and therefore is effective in improving the throughput of the substrate processing in the substrate processing apparatus 100.

(d) In the embodiments, when the result of determination by the checking function is the error, the error data are returned to the group management apparatus 274. Therefore, it is very effective in completely eliminating the risk of virus infection on the substrate processing apparatus 100.

(e) In the embodiments, when the telegram data are received from the group management apparatus 274, the program execution process that reads out and executes the process program corresponding to the telegram data from the storage device 2603 is performed based on the contents of the correspondence table. Therefore, even when only the telegram data is transmitted and received, it is possible to specify a process program that matches the command statement of the telegram data and selectively read out and execute the process program from the process program group in the storage device 2603. That is, it is possible to realize the remote control using the telegram data for the processing operation in the substrate processing apparatus 100, which is very effective in eliminating the risk of virus infection on the substrate processing apparatus 100.

(f) In the embodiments, communication between the host apparatus 500 and the group management apparatus 274 may be performed by using a plurality of protocols, but only the telegram data is transmitted and received between the group management apparatus 274 and the substrate processing apparatus 100. That is, the group management apparatus 274 functions as a gate that makes the out-of-system network 269 and the LAN 268 independent from each other while ensuring a versatility of communication with the host apparatus 500, and transmits and receives only the telegram data to and from the substrate processing apparatus 100. Therefore, the group management apparatus 274 can provide a host interface for remote control of the substrate processing apparatus 100, which can eliminate the risk of virus infection without requiring any restrictions on communication in the out-of-system network 269.

### OTHER EMBODIMENTS

Although the embodiments of the present disclosure have been specifically described above, the present disclosure is not limited to the above-described embodiments, but various changes can be made without departing from the gist thereof.

For example, in the above-described embodiments, the method of alternately supplying the first process gas and the second process gas to form the film has been described, but other methods may also be applied. For example, the process may be performed by using one type of gas or three or more types of gases instead of two types of gases.

Further, in the above-described embodiments, the examples in which the SiN film is formed on the wafer surface by using the DCS gas, which is the silicon-containing gas, as the precursor gas and the NH₃ gas, which is the nitrogen-containing gas, as the reaction gas have been shown, but other gases may also be applied to the film formation. For example, there are an oxygen-containing film, a nitrogen-containing film, a carbon-containing film, a boron-containing film, a metal-containing film, a film containing more than one of these elements, and the like. Examples of these films may include an AlO film, a ZrO film, a HfO film, a HfAlO film, a ZrAlO film, a SiC film, a SiCN film, a SiBN film, a TiN film, a TiC film, a TiAlC film, and the like.

Further, in the above-described embodiments, the film-forming process is taken as an example as the process performed in the substrate processing step, but the present disclosure is not limited thereto. That is, the present disclosure can be applied to processes other than the film-forming process taken as an example in the above-described embodiments. For example, there are diffusion treatment, oxidation treatment, nitridation treatment, oxynitridation treatment, reduction treatment, oxidation-reduction treatment, etching treatment, heat treatment, and the like using plasma. Further, for example, the present disclosure may be applied to plasma oxidation treatment or plasma nitridation treatment of a substrate surface or a film formed on a substrate by using only a reaction gas. The present disclosure can also be applied to plasma annealing treatment by using only a reaction gas. These treatments may be used as the first process, and then the above-described second process may be performed.

Further, in the above-described embodiments, the cases where the substrate processing module 2000 that performs the substrate processing is configured as a single-wafer type substrate processing apparatus, that is, a configuration of the apparatus that processes one wafer 200 in one process chamber 201, have been shown, but the present disclosure is not limited and may also be applied to apparatuses in which a plurality of substrates are arranged in a horizontal direction or a vertical direction.

Further, for example, in the above-described embodiments, the manufacturing process of the semiconductor device has been described, but the present disclosure can be applied to processes other than the manufacturing process of the semiconductor device. For example, the present disclosure may be applied to substrate processing such as a liquid crystal device manufacturing process, a solar cell manufacturing process, a light-emitting device manufacturing process, a glass substrate processing process, a ceramic substrate processing process, a conductive substrate processing process, and the like.

According to the present disclosure in some embodiments, it is possible to improve the throughput of substrate processing.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A substrate processing apparatus comprising:
a processor configured to process a substrate;
a transceiver connected to a group management device such that the transceiver can communicate with the group management apparatus, the transceiver being configured to transmit and receive only telegram data to and from the group management device; and
a controller configured to be capable of controlling a process performed by the processor based on the telegram data received by the transceiver.

2. The substrate processing apparatus of claim 1, wherein the controller is further configured to check the telegram data received by the transceiver.

3. The substrate processing apparatus of claim 2, further comprising a table memory configured to store table data recording a data size of the telegram data,
wherein the controller is further configured to determine, by the act of checking the telegram data, whether or not the data size of the telegram data received by the transceiver matches the data size recorded in the table data.

4. The substrate processing apparatus of claim 2, wherein the controller is further configured to transmit error data to the transceiver when a determination result from the act of checking the telegram data is an error.

5. The substrate processing apparatus of claim 3, wherein the controller is further configured to transmit error data to the transceiver when a determination result from the act of checking the telegram data is an error.

6. The substrate processing apparatus of claim 1, wherein the group management apparatus is capable of communicating with a host apparatus by using a plurality of protocols including a communication protocol of the telegram data.

7. The substrate processing apparatus of claim 1, further comprising a program memory configured to store a process program that prescribes the process performed by the processor,
wherein the controller is further configured to read out and execute a process program corresponding to the telegram data from the program memory based on the telegram data received by the transceiver.

8. The substrate processing apparatus of claim 1, wherein the telegram data is composed of text data.

9. The substrate processing apparatus of claim 1, wherein the telegram data includes size data.

10. The substrate processing apparatus of claim 1, wherein the telegram data has a predetermined size.

11. A substrate processing system comprising:
the substrate processing apparatus of claim 1; and
the group management apparatus connected to the substrate processing apparatus such that the group management apparatus can communicate with the substrate processing apparatus.

12. The substrate processing system of claim 11, further comprising a host apparatus configured to be capable of communicating with the group management apparatus by using a plurality of protocols including a communication protocol of the telegram data,
wherein the group management apparatus is configured to receive a plurality of types of data including the telegram data from the host apparatus and transmit only the telegram data among the plurality of types of data to the transceiver.

13. A method of manufacturing a semiconductor device, comprising:
transmitting and receiving only telegram data between a substrate processing apparatus configured to process a substrate and a group management apparatus connected to the substrate processing apparatus such that the group management apparatus can communicate with the substrate processing apparatus; and
controlling a process performed by the substrate processing apparatus based on the telegram data received by the substrate processing apparatus.

14. The method of claim 13, further comprising checking the telegram data received by the substrate processing apparatus.

15. The method of claim 14, wherein the act of checking the telegram data includes determining whether or not a data size of table data in which a data size of the telegram data is recorded matches the data size of the received telegram data.

16. The method of claim 15, further comprising transmitting error data when a determination result from the act of checking the telegram data is an error.

17. The method of claim 13, further comprising reading out and executing a process program corresponding to the received telegram data based on the telegram data.

18. A non-transitory computer-readable recording medium storing a program that causes, by a computer, a substrate processing apparatus to perform a process comprising:
transmitting and receiving only telegram data between the substrate processing apparatus configured to process a substrate and a group management apparatus connected to the substrate processing apparatus such that the group management apparatus can communicate with the substrate processing apparatus; and
controlling a process performed by the substrate processing apparatus based on the telegram data received by the substrate processing apparatus.
